(19) United States
(12) Patent Application Publication
(10) Pub. No.: US 2008/0304930 A1
(43) Pub. Date: Dec. 11, 2008

(54) Wheel restraint assembly and method

(75) Inventor: Mark Y. Zhan, Mokena, IL (US)

Correspondence Address: Meroni & Meroni, P.C., P.O. Box 309, Barrington, IL, 60011, US

(73) Assignee: Holland Company

(21) Appl. No.: 11/811,212

(22) Filed: Jun. 8, 2007

(51) Int. Cl. B60T 3/00

(52) U.S. Cl. 410/20

(57) ABSTRACT

A wheel restraint assembly pivots about a centralized axis for enabling enhanced assembly installation and removal. The wheel restraint assembly comprises a plate assembly and a brace assembly. The plate assembly comprises first and second plates, and certain hinge structure therebetween for effecting a plate-based axis of rotation. The brace assembly comprises certain anchoring structure; first and second links, certain wheel-engaging structure, and a brace lock means for selectively locking the wheel-engaging structure against a wheel via the anchor structure and first and second links. The anchoring structure is attached to the first plate, and the brace lock is attached to the second plate. The first and second plates are rotatable about the plate-based axis for locking and unlocking the plate assembly to and from the grating. The brace-lock prevents translation of the first and second brace-based axes when the wheel-engaging structure engages the wheel.

### BACKGROUND OF THE INVENTION

1. Technical Field

The present invention generally relates to a device for restraining wheels as borne by support surfaces. More particularly, the present invention relates to a wheel restraint device for use in cooperation with vehicle-bearing railroad car beds. The device, when attached to a railroad car bed adjacent a vehicular wheel and engaged with the wheel, prevents wheel displacement(s).

2. Description of the Prior Art

As noted by Winsor in U.S. Pat. No. 5,312,213, various means for anchoring vehicles borne by railway flatbed cars are known in the arts. Arguably, the most common traditional means to prevent vehicular displacement(s) during flatbed transport thereof is to “tie down” the vehicle to the supporting flatbed. The axially directed tension in the tie downs however, often proves inferior to other means for preventing displacements in three-dimensional space. In other words, if a tension is directed from the vehicle to a flatbed via a tie down, the displacement preventing force is axially directed through the tie down. Vehicle-displacing forces incurred during flatbed transport are multidimensional. Although these vehicle-displacing forces do comprise forces directed along the axis or axial direction of the tie down, other non-axial forces do occur on a rather frequent basis during vehicle transport. Certain wheel-chocking systems have thus been developed as a means to enhance displacement-prevention of flatbed transported vehicles. Some of the more pertinent art relating to these and similar other types of means for restraining vehicles and the wheel interfaces between vehicles and the flatbed support surfaces are briefly described hereinafter.

U.S. Pat. No. 4,659,266 ('266 patent), which issued to Thelen et al., discloses a Wheel Chocking Assembly. The '266 patent teaches a wheel chocking assembly especially suitable for securing a wide variety of automobiles to the deck of a railroad car includes a polyester strap member adapted to conform to the shape and extending over the top of an automobile's tire which is coupled to a pair of chock members formed as collapsible wedges and positioned in front of and behind the wheel. In one embodiment, the wedges are rotatably coupled to a pair of channels extending the length of the railroad car, and are collapsible for positioning of the automobiles during loading. Another embodiment utilizes a pair of wedges which are adjustably mounted in a telescopic fashion to frames extending inward from a channel attached to the deck of the railroad car at its sides, the channels being adapted to permit the frames to be swung up and out of the way during loading and unloading operations.

U.S. Pat. No. 4,668,140 ('140 patent), which issued to Blunden, discloses a Railroad Car with Chock Block Apparatus for Securing Transported Vehicles. The '140 patent teaches a railroad car having at least one deck for supporting and transporting four-wheel vehicles such as automobiles and trucks including a track secured to the deck longitudinally of the railroad car; a pair of movable chock blocks for each vehicle transported on the deck to secure the vehicle against longitudinal movement; each chock block including a bar with a first end and a second end; and pins on the bar first end for removably and releasably engaging holes in the track when the bar is substantially lateral to the track and spaced above the deck to prevent the bar first end from moving lateral to and longitudinally along the track and from being displaced out of lateral position to the track by pivoting, relative to the track, about a vertical axis, said means permitting ready release of the bar first end from the track so that the bar first end can be moved along the track.

U.S. Pat. Nos. 5,302,063 ('063 patent) and 5,312,213 ('213 patent), which issued to Winsor, disclose Wheel Chocking System(s) for Arresting Road Vehicles during Transportation. The '063 and '213 patents teach wheel chocking systems for restraining road vehicles being transported on a vehicle support surface of a transport vehicle, wherein the support surface has a grating disposed in at least a wheel support area where one or more road vehicles are positioned. The grating is formed by a grid of rods to which is secured chock members at desired positions relative to the position of the wheels of the road vehicle positioned over the wheel support area. Each chock has a base with disengageable attachment members in a lower engaging surface thereof to immovably secure the chock to the grating. The chock has an angled face plate which is positioned relative to an outer tread surface of a tire of a wheel to restrain movement thereof. Load transmitting members transfer a load applied to the face plate onto the base member and into the grating secured to the support surface. A lateral restraining member is provided on a side of the face plate and disposed adjacent an inner side wall portion of the tire to prevent lateral shifting of the vehicle positioned on the support surface.

The prior art further teaches a certain variety of wheel-chocking devices and the like for selectively preventing wheel (and vehicular) displacements during vehicular transport. The prior art appears to be silent, however, on a bifurcated chock or wheel restraint device, which device when rotated about the axis of rotation joining the halves functions to attach and detach the wheel restraint device to and from the support surface supporting the wheel. Further, the prior art appears to be silent on a pivotable wheel-engaging structure, which functions to maximize the wheel-to-structure contact surface area when placed into contact with a wheel. The prior art thus perceives a need for such an apparatus; and an attempt to meet this need is embodied by the teachings of the present invention. While not limited thereto in its utility, the present invention is particularly well suited for use in combination with grating-style support surface and wheels of varying radii as borne thereupon.

### SUMMARY OF THE INVENTION

Accordingly, it is primary object of the present invention to a wheel restraint assembly that pivots about a centralized axis thereby bifurcating the assembly and enabling unique installation possibilities. Further, the structure engageable with the target wheel is pivotable about an axis for enhancing or maximizing the contact surface area at the structure-to-wheel interface. To achieve these and other readily ascertainable objectives, the present invention essentially provides a wheel restraint assembly for preventing wheel displacements, which wheel restraint assembly essentially comprises a base plate assembly and a wheel brace assembly. The base plate assembly comprises first and second plate portions, a brace-attachment surface, a grating-attachment surface, and axis-effecting means for effecting a plate-based axis of rotation intermediate the first and second plate portions. The first and second plate portions each comprise grating-receiving structure at the grating-attachment surface parallel to the axis-effecting means.

The wheel brace assembly comprises certain anchoring structure, first and second links, certain wheel-engaging structure, brace-locking means for selectively locking the wheel-engaging structure against a wheel via the anchor structure and first and second links, and first, second, and third brace-based axes of rotation. The anchoring structure is attached to the first plate portion, and the brace-locking means are attached to the second plate portion. The first link links the brace-locking means to the wheel-engaging structure via the first and second brace-based axes. The second link links the wheel-engaging structure to the anchor structure via the second and third brace-based axes. The third brace-based axis is selectively and translatably fixed at the anchor structure, and the first and second brace-based axes are selectively translatable via the first link.

A target wheel being positionable upon a grating or similar other support surface such that the wheel axis of rotation is parallel to the grating. The plate assembly is positionable adjacent the wheel upon the grating/support surface at a first grating position via the grating-receiving structure such that the plate-based axis is parallel to the wheel axis. The first and second plate portions are rotatable about the plate-based axis for locking and unlocking the plate assembly to and from the grating. The first and second brace-based axes are translatable for engaging and disengaging the wheel via the wheel-engaging structure. Finally, the brace-locking means essentially function to prevent translation of the first and second brace-based axes when the wheel-engaging structure engages the wheel.

### BRIEF DESCRIPTION OF THE DRAWINGS

Other features of my invention will become more evident from a consideration of the following brief description of patent drawings:

FIG. 1 is a diagrammatic side view type depiction of a surface-supported wheel with the wheel restraint assembly according to the present invention attached to the support surface in adjacency to the surface-supported wheel.

FIG. 2 is a first sequential side view type depiction of a lock-outfitted plate assembly according to the present invention in superior adjacency to a grating type support surface in a non-assembly-installed configuration.

FIG. 3 is a first sequential end view type depiction of the plate assembly otherwise depicted in FIG. 2 showing a pinning mechanism in phantom rotating from a stowed position to a locking position.

FIG. 4 is a second sequential side view type depiction of a lock-outfitted plate assembly according to the present invention in superior adjacency to a grating type support surface in an assembly-installed configuration.

FIG. 5 is a second sequential end view type depiction of the plate assembly otherwise depicted in FIG. 4 showing a pinning mechanism in the locked position.

FIG. 6 is a side view type depiction of a plate assembly according to the present invention in an assembly-installed configuration with a fragmentary grating-receiving section thereof enlarged for clarity of reference.

FIG. 7 is a dual sequential side view type depiction of an outfitted plate assembly in superior adjacency to channel-receivable axial grating structure, the top depiction depicting the plate assembly in an assembly-installed configuration, and the bottom depiction depicting the plate assembly in a non-assembly-installed configuration.

FIG. 8 is a bottom view of the plate assembly according to the present invention showing grating-receiving channels at opposite ends of the plate assembly.

FIG. 9 is a fragmentary end view of a pinning mechanism outfittable upon the plate assembly of the present invention showing the pinning mechanism in a locked position.

FIG. 10 is a fragmentary side view of the pinning mechanism outfittable upon the plate assembly of the present invention showing the pinning mechanism in a locked position.

FIG. 11 is a fragmentary first sequential side view depiction of the plate and brace assemblies according to the present invention attached to a support surface in the assembly-installed position adjacent a wheel in a brace-relaxed first brace configuration.

FIG. 12 is a fragmentary second sequential side view depiction of the plate and brace assemblies according to the present invention otherwise depicted in FIG. 11 in a brace-actuated second brace configuration.

FIG. 13 is a fragmentary third sequential side view depiction of the plate and brace assemblies according to the present invention otherwise depicted in FIG. 11 in a brace-actuated and brace-locked third brace configuration.

FIG. 14 is a fragmentary first comparative side view depiction of the plate and brace assemblies according to the present invention attached to a support surface in the assembly-installed position adjacent a wheel having a relatively small radius with the linkage in a first anchor setting.

FIG. 15 is a fragmentary second comparative side view depiction of the plate and brace assemblies according to the present invention attached to a support surface in the assembly-installed position adjacent a wheel having a medium sized radius with the linkage in a second anchor setting.

FIG. 16 is a fragmentary first comparative side view depiction of the plate and brace assemblies according to the present invention attached to a support surface in the assembly-installed position adjacent a wheel having a relatively large radius with the linkage in a third anchor setting.

FIG. 17 is an enlarged fragmentary first sequential side view depiction of the plate and brace assemblies according to the present invention in the assembly-installed position in a brace-relaxed first brace configuration.

FIG. 18 is an enlarged fragmentary second sequential side view depiction of the plate and brace assemblies according to the present invention otherwise depicted in figure No. 17 in a brace-actuated second brace configuration.

FIG. 19 is an enlarged fragmentary third sequential side view depiction of the plate and brace assemblies according to the present invention otherwise depicted in FIG. 17 in a brace-actuated and brace-locked third brace configuration.

FIG. 20 is a fragmentary first sequential end view depiction of the plate and brace assemblies otherwise depicted in FIG. 11.

FIG. 21 is a fragmentary first sequential end view depiction of the plate and brace assemblies otherwise depicted in FIG. 17.

FIG. 22 is a fragmentary first sequential end view depiction of the plate and brace assemblies otherwise depicted in FIG. 12.

FIG. 23 is a fragmentary first sequential end view depiction of the plate and brace assemblies otherwise depicted in FIG. 18.

FIG. 24 is a fragmentary first sequential end view depiction of the plate and brace assemblies otherwise depicted in FIG. 13.

FIG. 25 is a fragmentary first sequential end view depiction of the plate and brace assemblies otherwise depicted in FIG. 19.

FIG. 26 is a top view type depiction of the plate assembly with an anchoring structure, first linkage and wheel-engaging structure mounted to a first plate of the plate assembly.

FIG. 27 is a side view type depiction of the structures otherwise depicted in FIG. 26.

FIG. 28 is a top view type depiction of the plate assembly with an anchoring structure, first linkage, wheel-engaging structure, and strap-spooling assembly mounted to a first plate of the plate assembly.

FIG. 29 is a side view type depiction of the structures otherwise depicted in FIG. 28.

FIG. 30 is an enlarged side view type depiction of a first linkage and wheel-engaging structure otherwise depicted in FIGS. 27 and 29.

FIG. 31 is an end view of wheel-engaging structure otherwise depicted in FIG. 29 showing laterally opposed first linkage members.

FIG. 32 is a side view type depiction of a second linkage with attached lifter assembly otherwise removed from FIGS. 27 and 29.

FIG. 33 is an end view type depiction of a second linkage with attached lifter assembly otherwise depicted in FIG. 32.

FIG. 34 is an enlarged side view type depiction of the lifter assembly otherwise depicted in FIG. 32.

FIG. 35 is an enlarged top view type depiction of the lifter assembly otherwise depicted in FIG. 34.

FIG. 36 is an enlarged side view type depiction of a foot-operable drum tensioner of the strap-spooling assembly with radially extending reinforcing plates.

FIG. 37 is an enlarged end view type depiction of the foot-operable drum tensioner with radially extending reinforcing plates otherwise depicted in FIG. 36.

FIG. 38 is a plan type depiction of a tensioner override with attached foot-engaging pedal of the strap-spooling assembly.

FIG. 39 is an end view type depiction of the tensioner override with attached foot-engaging pedal otherwise depicted in FIG. 38.

FIG. 40 is an enlarged end view type depiction of a first end of the plate and brace assemblies depicting the centralized brace-locking foot pedal in a non-actuated upright state and the pinning mechanism in a plate-locking state.

FIG. 41 is an enlarged side view type depiction of the wheel restraint assembly according to the present invention in an assembly-installed configuration showing an optional strap-spooling assembly attached thereto and the brace assembly laterally displaced a full length such that the wheel-engaging structure is substantially orthogonal to the plane of the plate assembly.

FIG. 42 is an enlarged side view type depiction of the wheel restraint assembly otherwise depicted in FIG. 1 in an assembly-installed configuration showing (1) an optional strap-spooling assembly attached thereto, (2) the brace assembly laterally displaced a partial length such that the wheel-engaging structure is in a position for tangentially engaging a wheel, (3) the lateral restraint members being doubly shown in a wheel-restraining position and in a stowed position, and (4) the foot-operable lifter assembly being rotated through an arc length for locking the wheel-engaging structure in the position for tangentially engaging a wheel.

### DETAILED DESCRIPTION OF THE PREFERRED EMBODIMENT(S)

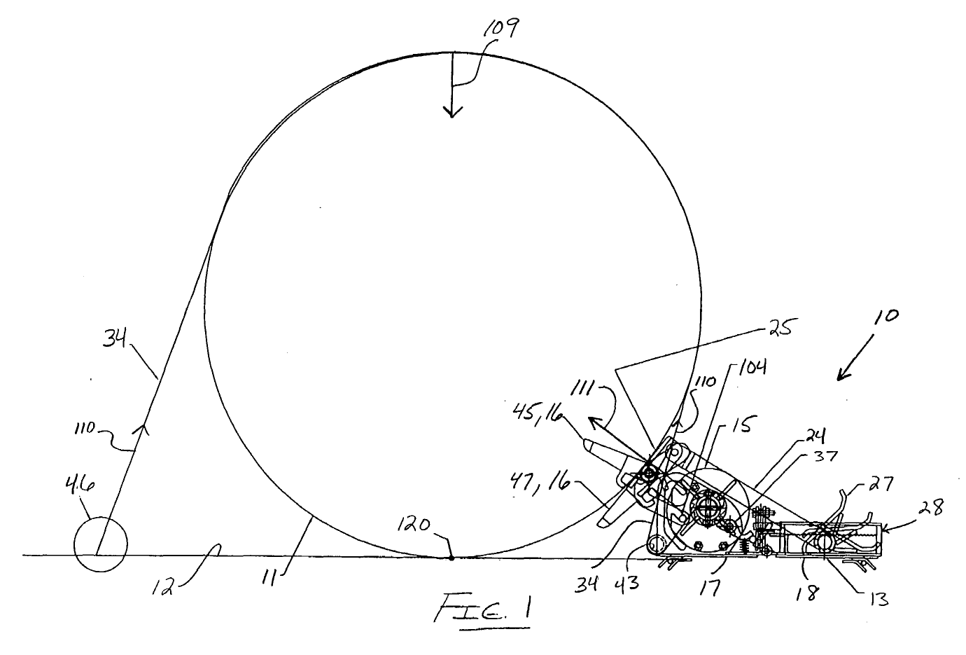

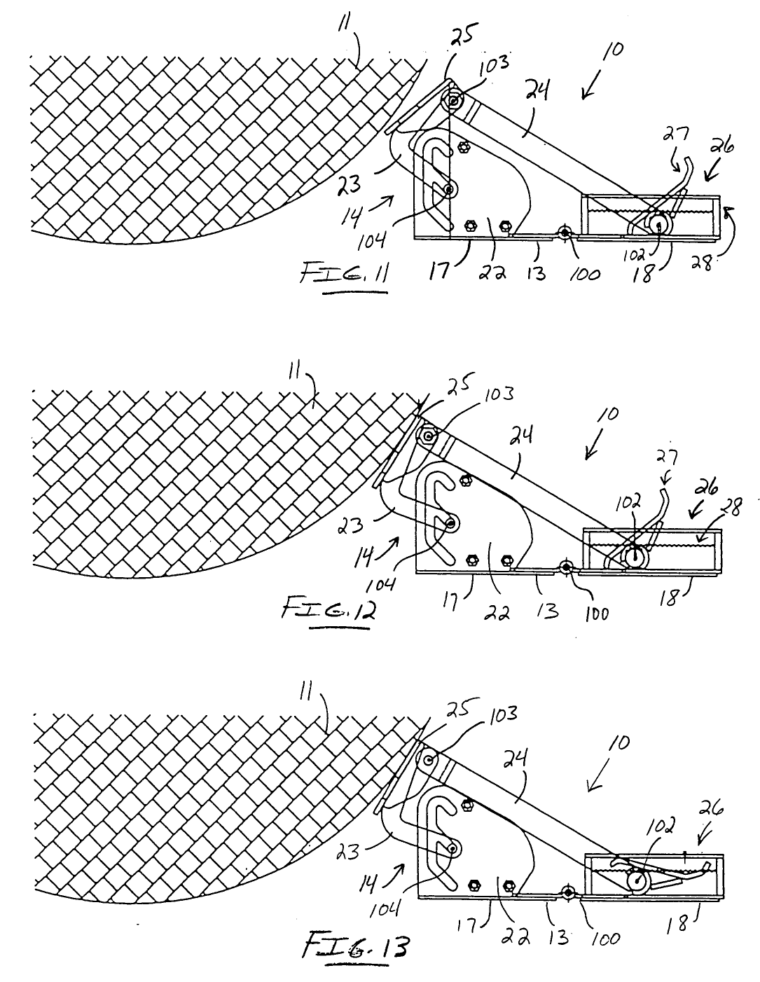

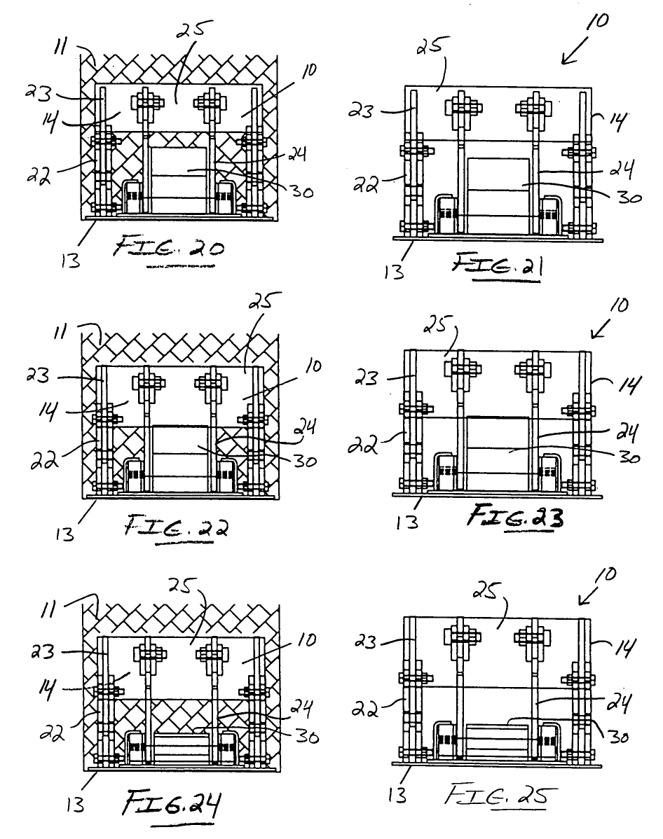

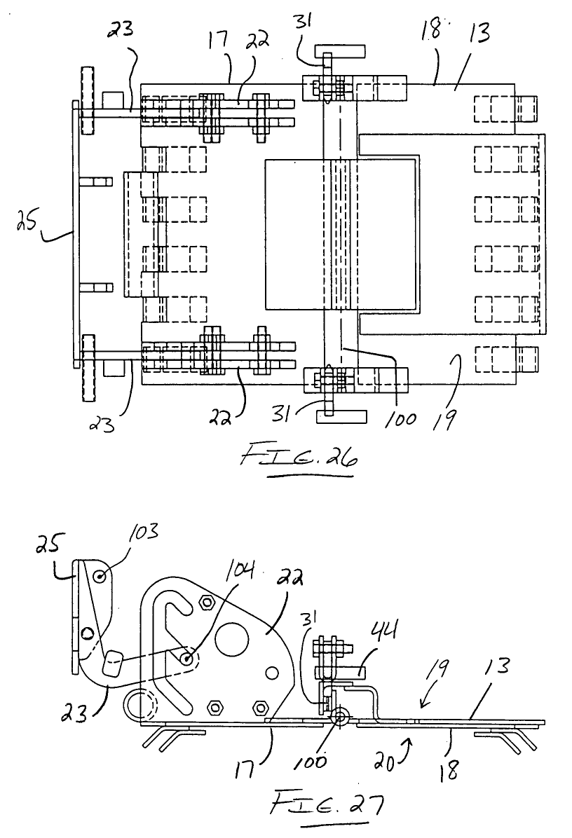

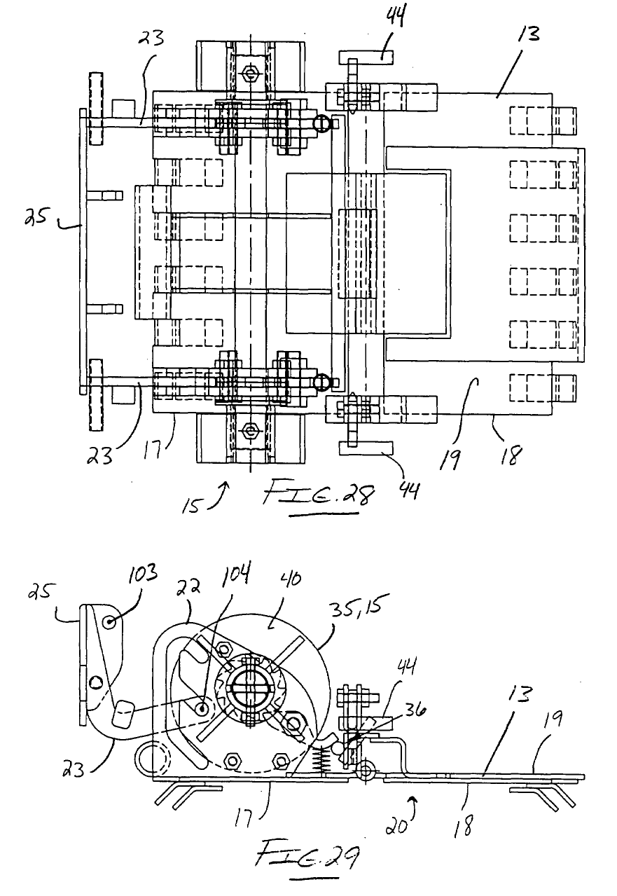

Referring now to the drawings with more specificity, the preferred embodiment of the present invention generally concerns a wheel restraint assembly 10 for preventing a wheel 11 (as attached to a vehicle) from rolling or becoming otherwise displaced from a preferred anchored position. The wheel restraint assembly 10 of the present invention is generally illustrated and referenced in FIGS. 1, 11-25, 41, and 42; and a wheel 11 targeted by the present application is generally illustrated and referenced in FIGS. 1, 11-16, 20, 22, and 24. In this last regard, it is noted that vehicular wheels, such as the illustrated wheel 11, interface intermediate a vehicle (not specifically illustrated) and a support surface as at 12 in FIGS. 1-5, and 42, and thereby provide convenient points for vehicular restraint upon flatbed railway cars and the like, which are typically outfitted with a grating type support surface 12. The wheel restraint assembly 10 according to the present invention is particularly well suited for attachment to grating type wheel (vehicle) support surfaces 12 and is engageable with wheel 11 for preventing displacement of the wheel 11 relative to the support surface 12.

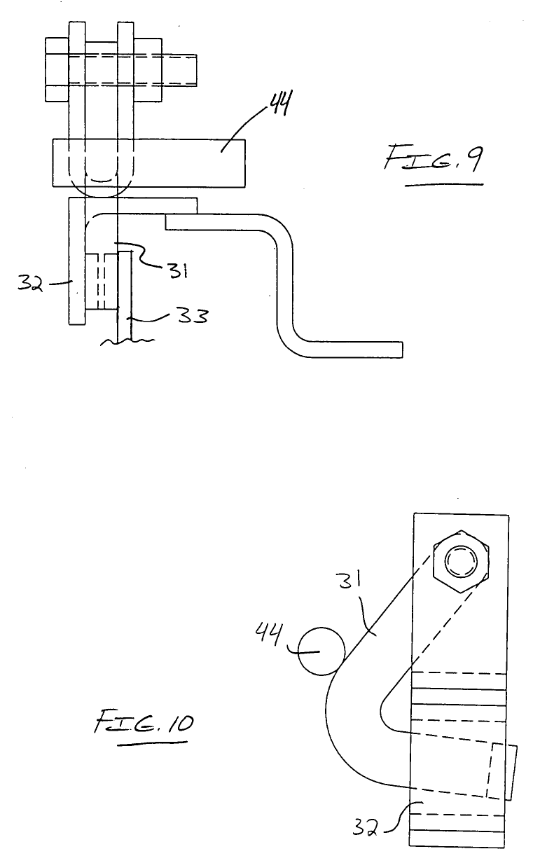

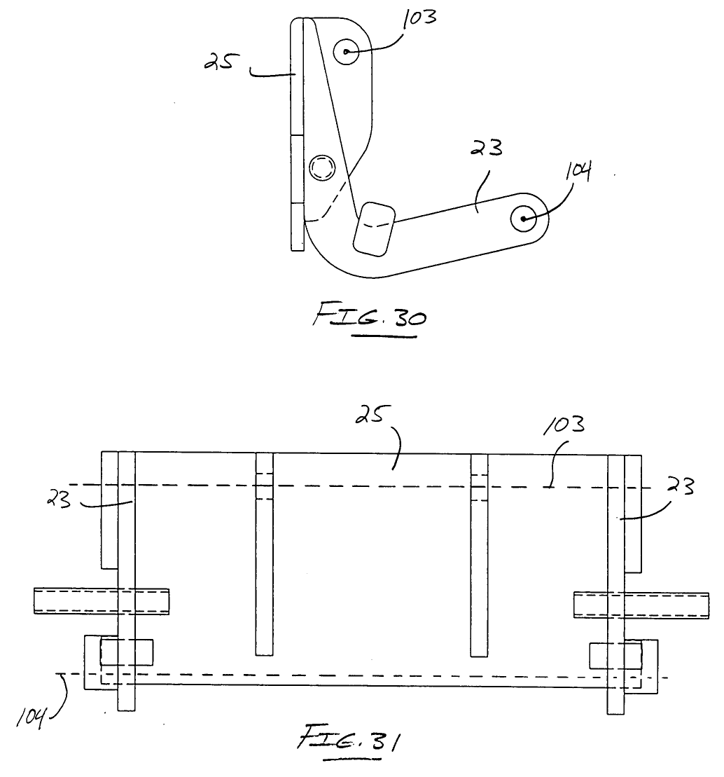

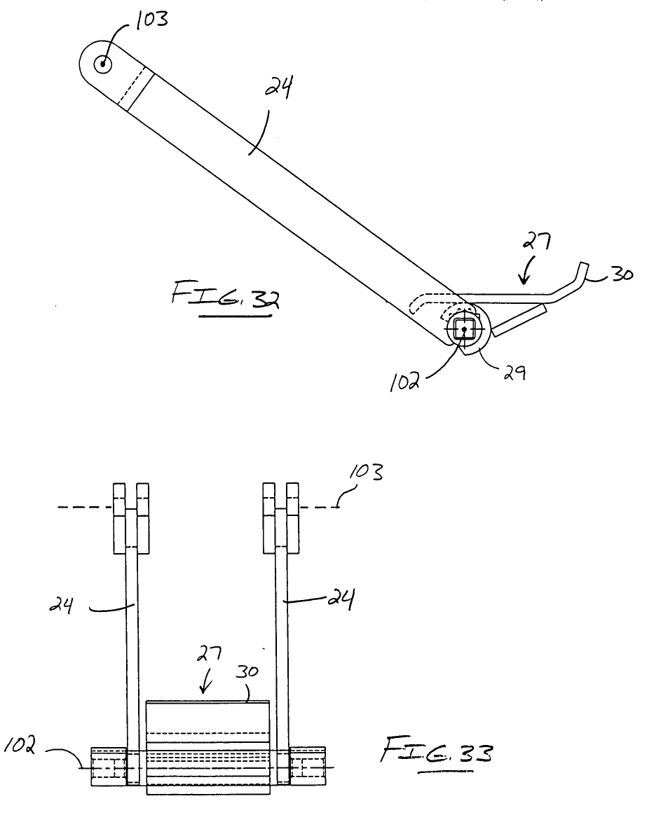

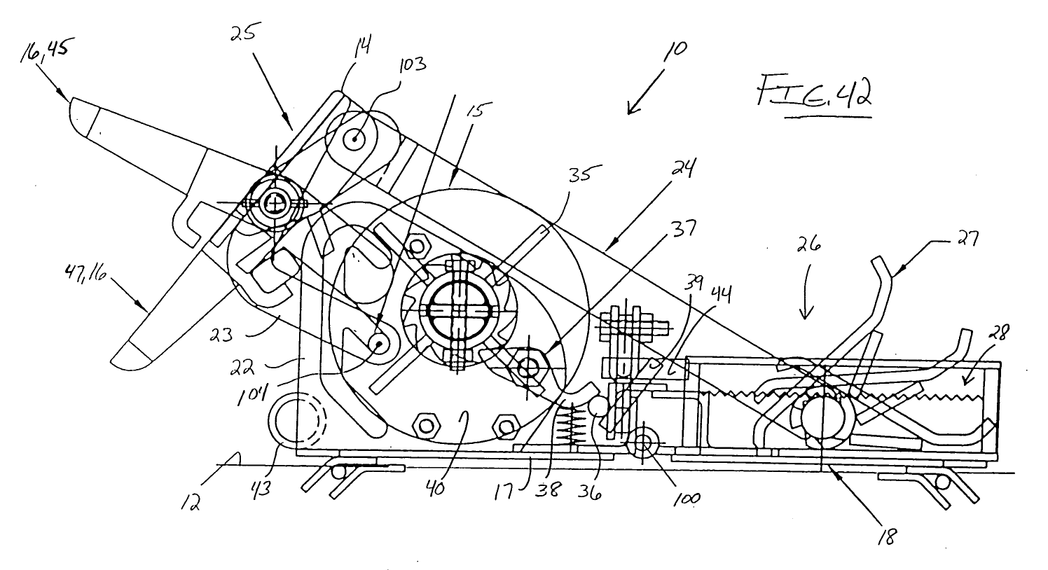

The wheel restraint assembly 10 according to the present invention preferably and essentially comprises a base plate assembly 13 as generally depicted and referenced in FIGS. 1-8, 11-29, 40-42; and a wheel brace assembly 14 as generally depicted and referenced in FIGS. 11-25, 41, and 42. The wheel restraint assembly further preferably and optionally comprises a number of other features, including certain plate-locking means; a strap assembly 15 as generally depicted and referenced in FIGS. 28, 29, 40-42; and one (or two) stowable laterally-positioned or lateral restraint arm(s) or member(s) 16 as generally depicted and referenced in FIGS. 1 and 42. The lateral restraint arm(s) 16 are engageable with the wheel 11 for preventing axial displacement of the wheel 11 relative to the wheel restraint assembly 10. FIGS. 1 and 42 depict the arm 16 in an extended, wheel-engaging position as at 45 and a stowed position as at 47.

The base plate assembly 13 essentially comprises a first plate portion 17 as depicted and referenced in FIGS. 1, 2, 4, 6-8, 11-19 22, 26-29, 41, and 42; a second plate portion 18 as depicted and referenced in FIGS. 1-8, 11-19, 26-29, and 40-42; a brace-attachment surface 19 as generally referenced in FIGS. 2-7, and 26-29; a grating-attachment or grating-opposing surface 20 as generally referenced in FIGS. 2, 4-8, 27, and 29; and certain hinge means or similar other axis-effecting means for effecting a plate-based axis of rotation 100 intermediate the first plate portion 17 and the second plate portion 18 as generally referenced in FIGS. 2-8, 26, 27, 41, and 42. The first and second plate portions 17 and 18 each comprise certain grating-receiving structure 21 attachable to, or otherwise cooperably associated with, the grating-attachment surface 20, which receiving structures 21 each comprise a receiving axis 101 substantially parallel to the axis-effecting means or plate-based axis of rotation 100 as generally depicted and referenced in FIG. 8.

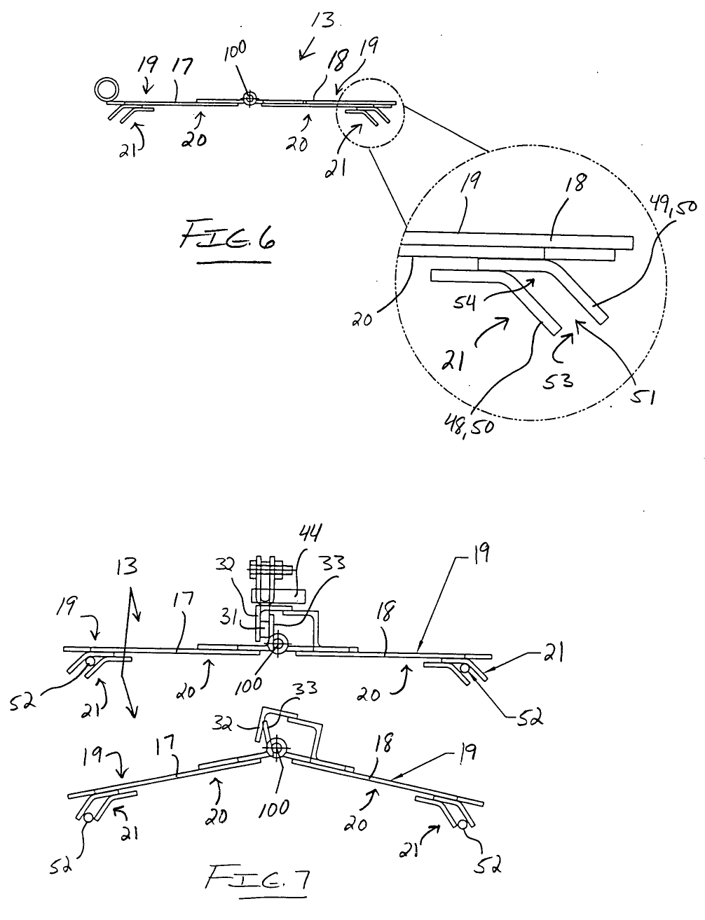

From a further inspection of the noted figures, it may be readily understood that the grating-receiving structure 21 may be defined by a first row 48 of teeth 50 and a substantially parallel second row 49 of teeth 50. The rows 48 and 49 of teeth 50 are oriented such that the teeth 50 form tooth pairs, whereby each tooth pair defines an axis receiving channel as at 51 in FIG. 6. The axis-receiving channels 51 have a substantially uniform channel axis 101 for receiving axial grating structure 52 as particularly depicted in FIG. 7. Notably, the channel axis-receivable grating structure(s) 52 are parallel to the plate-based axis of rotation 100. The first and second plate portions 17 and 18 are rotatable about the plate-based axis 100 intermediate an assembly-installation angle as generally depicted in FIGS. 2 and 7 (bottom depiction), and an assembly-installed (180 degree) angle as generally depicted in FIG. 1, 4-7 (top), 11-29, and 40-42. The axis-receiving channels 51 comprises a channel mouth 53, a channel bottom 54, and a channel depth extending therebetween as generally depicted in FIG. 6. The channel-axis-receivable grating structure 52 are receivable at the channel mouth 53 at the assembly-installation angle as generally depicted in FIG. 7 (bottom) and displaceable a distance equal in magnitude to the channel depth toward the channel bottom 54 when rotated to the assembly-installed angle as generally depicted in FIG. 7 (top).

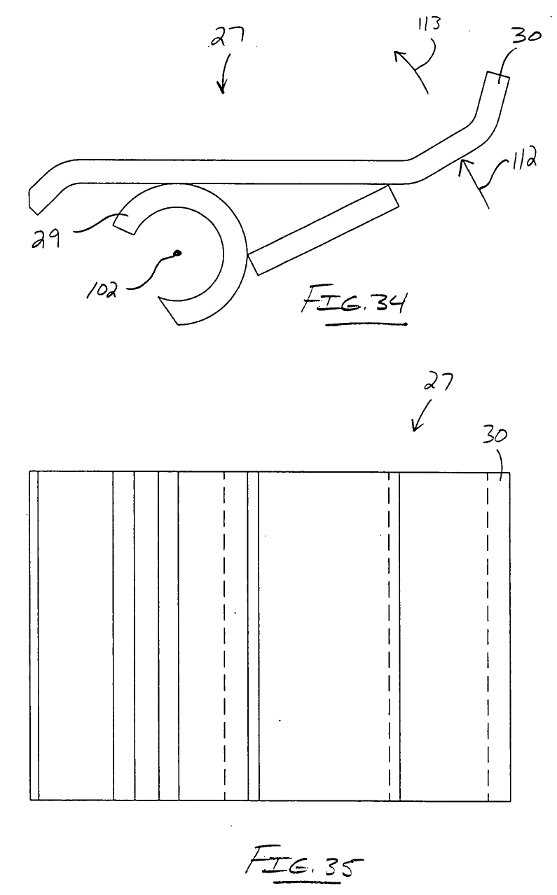

The wheel brace assembly 14 preferably comprises certain anchor structure 22 as depicted and referenced in FIGS. 11-29, 41, and 42; a first (angled or L-shaped) link 23 as depicted and referenced in FIGS. 11-31, 41, and 42; a second (linear) link 24 as depicted and referenced in FIGS. 1, 11-25, 32, 33, 40-42; certain wheel-engaging structure as may be defined by a plate 25 as depicted and referenced in FIG. 1, 11-31, 41 and 42; certain brace-locking means (as at 26) for selectively locking the wheel-engaging structure 25 against wheel 11 (via the anchor structure 22, first link 23, and second link 24) as depicted and referenced in FIGS. 11-19, 41, and 42; and a series of pivot points or brace-based axes of rotation, including a first brace-based axis of rotation as referenced at 102 in FIGS. 11-19, 32, 33, 34, 40, and 41; a second brace-based axis of rotation as referenced at 103 in FIGS. 11-13, 15-19, 27, 29-33, 41, and 42; and a third brace-based axis of rotation as referenced at 104 in FIGS. 11-19, 27, 29-31, 41, and 42.

From an inspection of the noted figures, it may be readily understood that the anchor structure 22 is attached to the first plate portion 17, and the brace-locking means 26 are attached to the second plate portion 18. Further, the link 24 links the brace-locking means 26 to the wheel-engaging structure 25 via the brace-based axes 102 and 103, and the link 23 links the wheel-engaging structure 25 to the anchor structure 22 via the brace-based axes 103 and 104. The brace-based axis 104 is selectively and translatably fixed at the anchor structure 22, and the brace-based axes 102 and 103 are selectively translatable via the link 24.

The wheel 11 is positionable upon a grating or other support surface 12 such that the wheel axis of rotation is parallel to the surface 12 as generally depicted in FIGS. 1, 11-16, 20, 22, and 24. From an inspection of the noted figures, it may be readily understood that the plate assembly 13 is positionable adjacent the wheel 11 upon the grating or surface 12 at a first grating/surface position. The plate assembly 13 is attachable to the surface 12 via the grating-receiving structure 21 such that the plate-based axis 100 is parallel to the wheel's axis of rotation. The first and second plate portions 17 and 18 are rotatable about the plate-based axis 100 for locking and unlocking the plate assembly 13 to and from the grating. The brace-based axes 102 and 103 are translatable via the link 24 and brace-locking means 26 for engaging and disengaging the wheel 11 via the wheel-engaging structure 25. The brace-locking means 26 function to selectively prevent translation of the brace-based axes 102 and 103 when the wheel-engaging structure 25 engages the wheel 11.

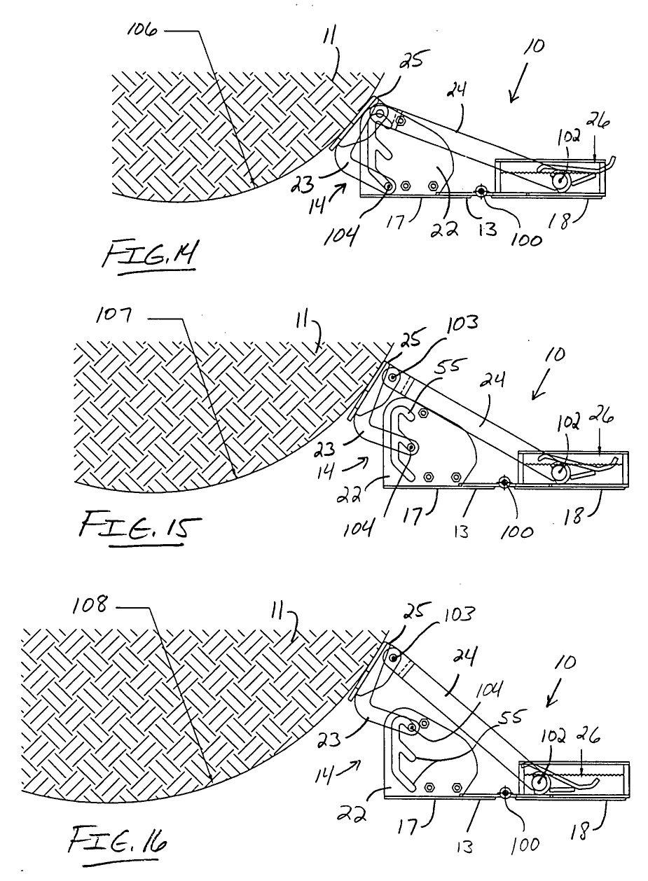

A primary feature of the present invention is a pivoting front plate or wheel-engaging structure 25, which structure 25 is placed against the wheel 11 after adjusting to one of several vertical height positions as enabled by way of the anchor structure 22 as generally and comparatively depicted in FIGS. 14-16. In this last regard, FIG. 14 depicts a first vertical height position as enabled by the anchoring structure 22 whereby the axis 104 is selectively and translatably fixed in an inferior most position for bracing a wheel 11 having a first, relatively small wheel radius 106. Further, FIG. 15 depicts a second vertical height position whereby the axis 104 is selectively and translatably fixed in a middle position for bracing a wheel 11 having a second wheel radius 107 of relatively medium magnitude.

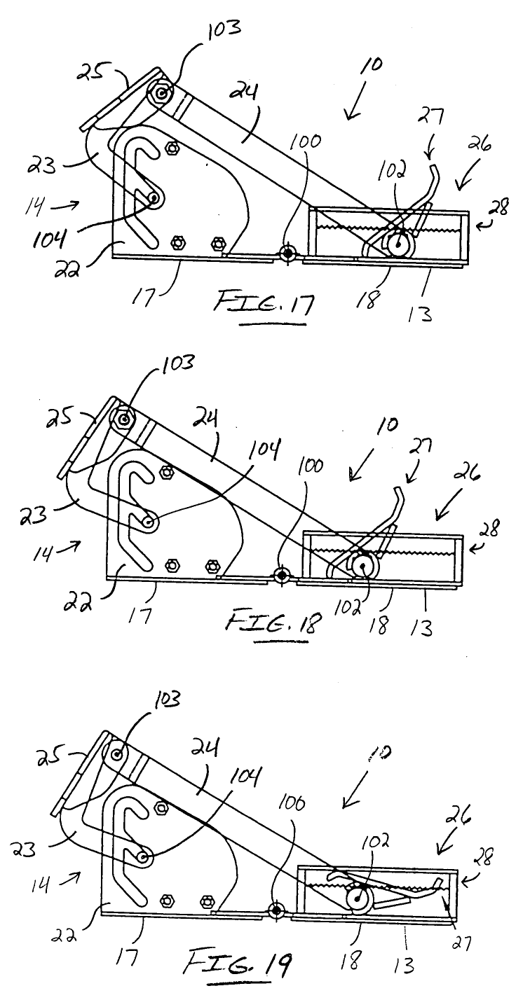

Finally, FIG. 17 depicts a third vertical height position whereby the axis 104 is selectively and translatably fixed in a superior most position for bracing wheel 111 having a third wheel radius 108 of relatively large magnitude. It should thus be understood that the anchor structure 22 preferably comprises a plurality of axis settings as exemplified by the foregoing height positions. The axis settings enable the user to selectively fix the brace-based axis 104 at the anchor structure 22, which selectively fixable brace-based axis 104 may well function to enable the assembly 10 to more effectively accommodate wheels 11 of varying radii.

The pivoting plate or wheel-engaging structure 25 effectively functions to eliminate any gap at the wheel-to-plate or wheel-to-brace interface. Notably, the state of the art does not teach this feature and often permits gaps of up to ¾ inches intermediate the wheel and the wheel-restraining device. These gaps, as provided by the state of the art, contribute to climbing of the wheel over chocks resulting in damage. At the base of the wheel-engaging structure 25 via the link 24 are the brace-locking means 26. It is contemplated that the brace-locking means 26 may be preferably defined by a lifter assembly 27 (as generally depicted and referenced in FIGS. 1, 11, 12, 17-19, and 32-35) in cooperative association with a toothed rack assembly 28 (as generally depicted and referenced in FIGS. 1, 11, 12, 17-25, 41, and 42).

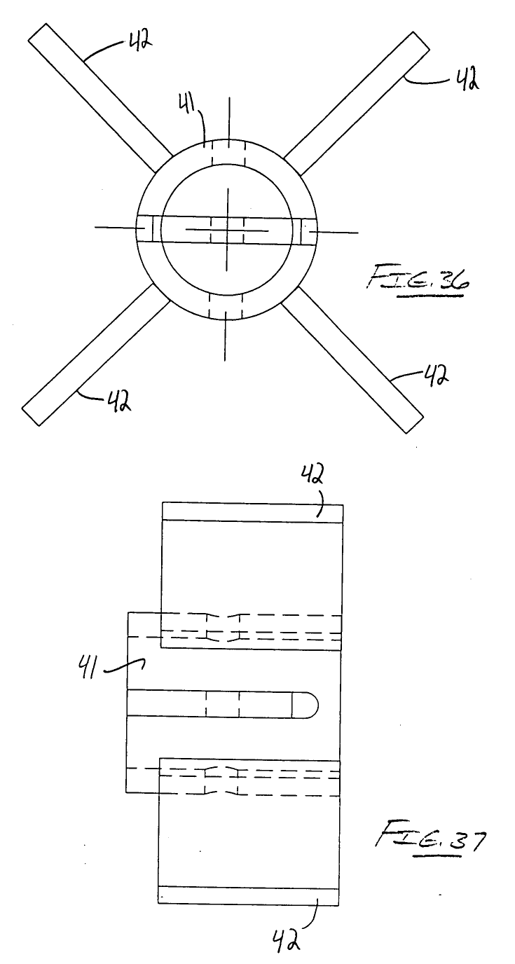

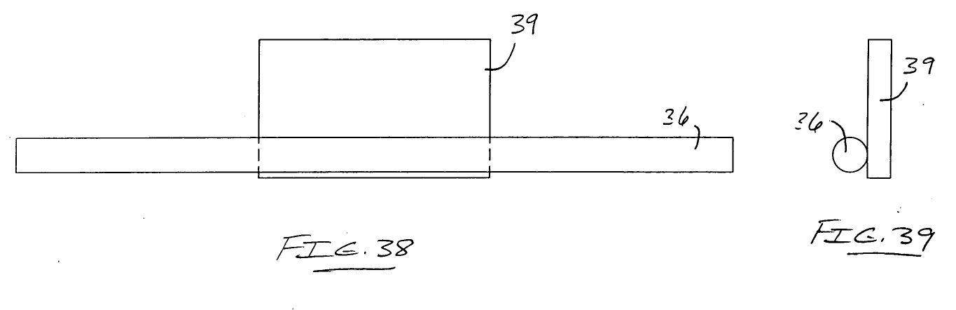

The lifter assembly 27 preferably comprises a cam lifter 29 as further illustrated and referenced in FIGS. 32 and 34, and a foot-operable locking paddle 30 as illustrated and referenced in FIGS. 20-25, and 32-35. The axis 102 is translatable along a length of the toothed rack assembly 28 and when the wheel-engaging structure 25 engages the wheel 11, it may pivot about the axis 103 for maximizing the wheel-to-plate or wheel-to-brace contact surface area as comparatively depicted in FIG. 11 versus FIG. 12 and FIG. 17 versus FIG. 18. When the contact surface area is maximized as in FIGS. 12 and 18, the foot pressure may be applied to the foot paddle 30 for locking the brace assembly 14 in position and preventing longitudinal tire movement.

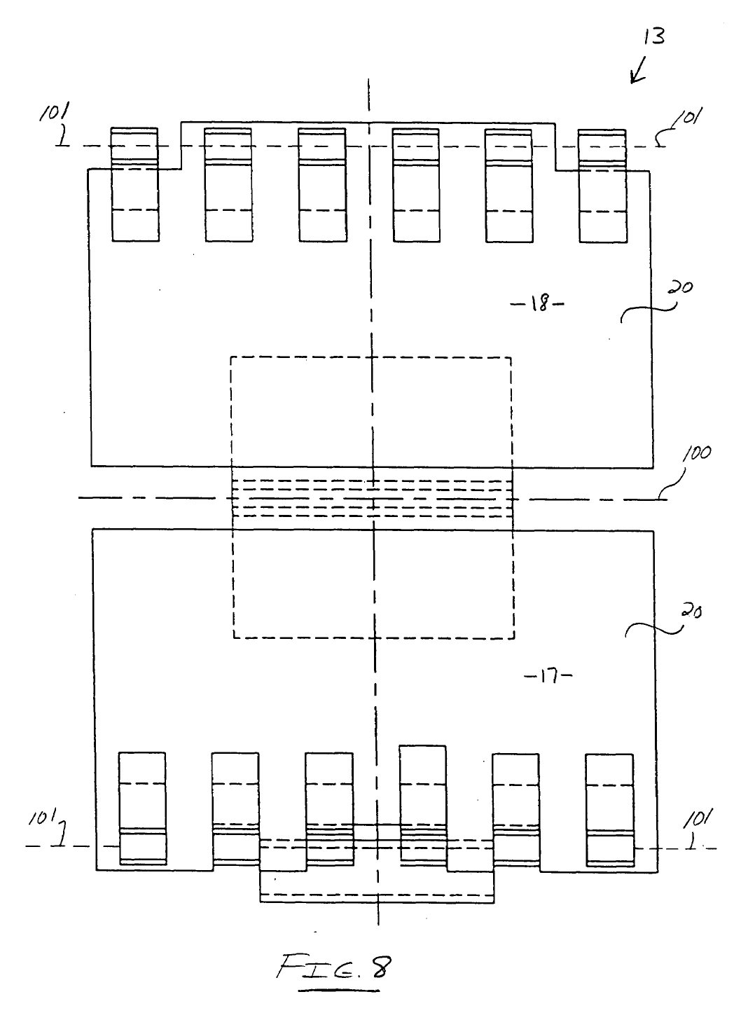

The plate assembly 13 of the wheel restraint assembly 10 may further preferably comprise certain plate-locking means for preventing pivot action intermediate the plate portions 17 and 18 when the plate assembly 13 is in an assembly-installed position or configuration as generally depicted in FIGS. 1, 4-6, 11-29, and 40-42. The plate-locking means according to the present invention may be defined, in part, by comprising a pinning mechanism or gravity locking bars 31 as generally depicted and referenced in FIGS. 2-5, 7, 9, 10, 26, 27, and 40; and opposing plate structures 32 (as depicted and referenced in FIGS. 2-5, 7, 9, 10, and 40) and 33 (as depicted and referenced in FIGS. 2, 4, 7, and 9).

From a comparative inspection of FIG. 2 versus FIG. 4, and from a consideration of FIG. 7, it may be readily understood that the opposing plate structures 32 and 33 are angled relative to one another when in a non-assembly-installed configuration or state as generally depicted in FIG. 2 and in the bottom depiction in FIG. 7, and that the opposing plate structures 32 and 33 are substantially parallel or spaced from one another when in the assembly-installed configuration as generally depicted in FIG. 4 and in the top depiction in FIG. 7. The pinning mechanism or gravity bar is preferably sized and shaped for sandwiched insertion intermediate the opposing plate structures 32 and 33 for preventing pivot action intermediate the first and second plate portions 17 and 18.

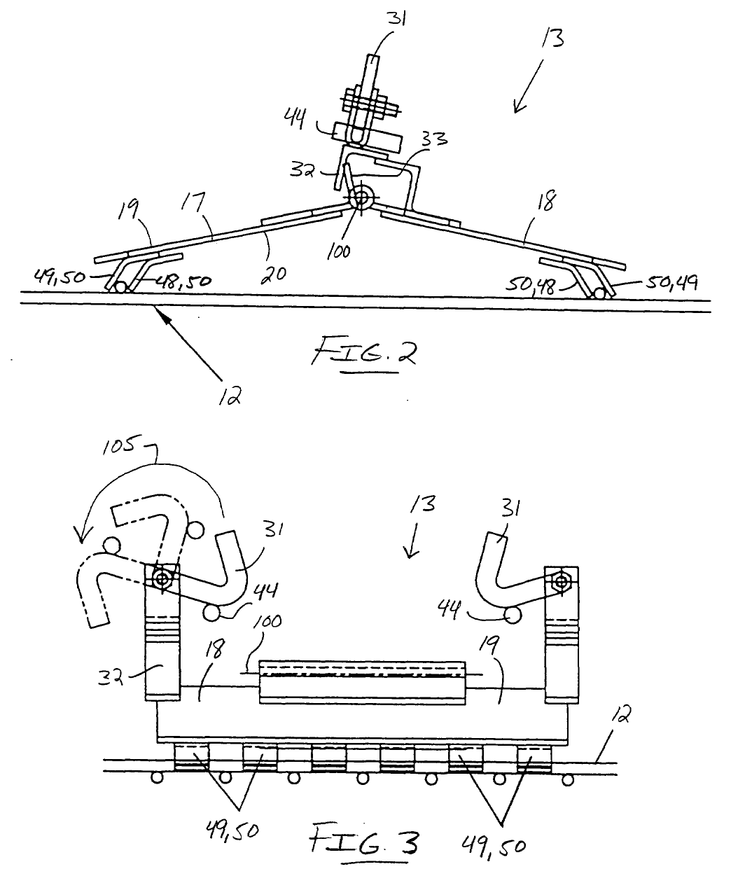

When in the non-assembly-installed configuration, it is contemplated that the pinning mechanism or bars 31 may be rotated about a pin axis of rotation to a stowed configuration as generally depicted in FIG. 2 and 3. When in the assembly-installed configuration, the bars 31 may be rotated about the pin axis of rotation as at 105 in FIG. 3 to pin the plate portions 17 and 18 and fix the axis of rotation 100 for locking the wheel restraint assembly 10 in the first grating/surface position or upon a select position upon the grating/surface 12. In other words, to prevent unintentional upward movement which could cause disengagement from the grating/surface 12, a mechanism of gravity swing bars 31 fill a set void intermediate opposing angles in the hinged base plate design. The swing bars 31 must be in the down position to lock the assembly 13. Bar handles 44 are further depicted and referenced in FIGS. 2-5, 9, 10, 27-29, 40-42. The handles 44 aid manipulation of the bars 31.

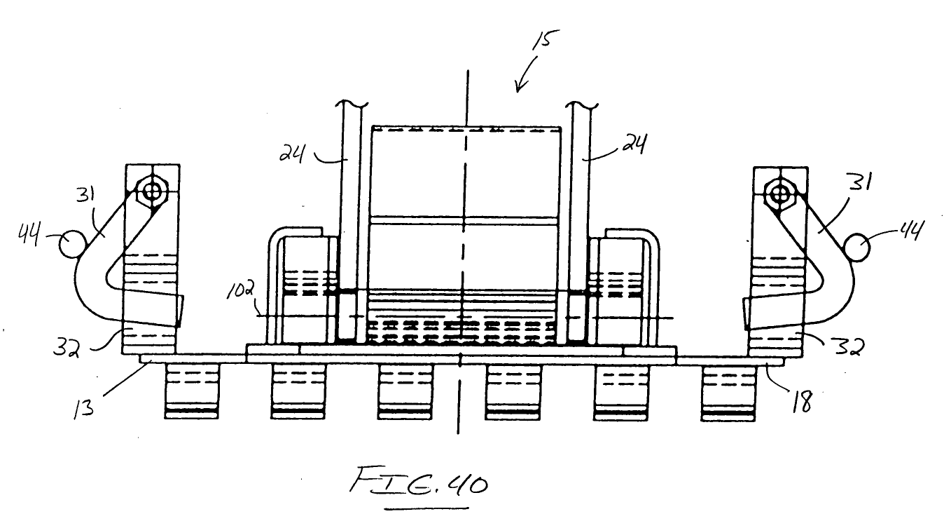

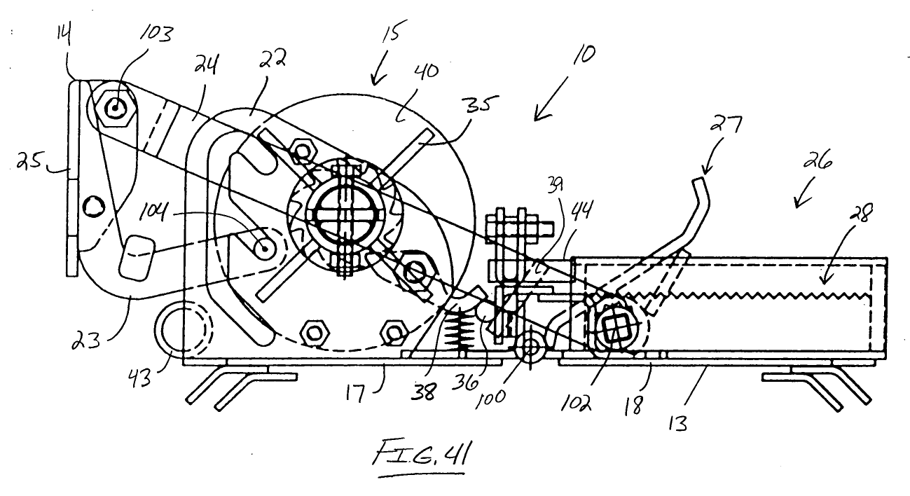

To further prevent wheel displacements, the wheel restraint assembly 10 according to the present invention may be outfitted with an optional web strap tensional device or strap assembly 15. The strap assembly 15 comprises a web strap 34 as depicted and referenced in FIG. 1 and certain tension-modifying means for modifying the tension in the strap length, which modifiable tension modifies the strap-retaining forces against the wheel 11. It is contemplated that the tension-modifying means may be preferably defined, in part, by the cooperative association of a spooling device 35 having reel bars; and a locking sprocket mechanism 37 as depicted in FIGS. 1 and 42 to allow tensioning of an applied strap. The sprocket mechanism 37 comprises a drum-locking pawl 38 as referenced in FIGS. 41 and 42; and an override 36 to the drum-locking pawl 38 to release tension, which override 36 is attached to a foot release lever 39 as generally depicted and referenced in FIGS. 29, 38, 39, 41, and 42. The spooling device 35 further comprises drum guide(s) 40 as depicted and referenced in FIGS. 29, 41, and 42; and a foot-operable drum tensioner 41 as depicted and referenced in FIGS. 36 and 37; which tensioner 41 comprises radially extending reinforcing plates 42.

The strap 34 of the strap assembly 15 comprises a first strap end (as at 46 in FIG. 1) and a second strap end. Strap end 46 may comprise a hook or similar other structure for hooking or becoming otherwise engaged with the grating/surface 12. In other words, the first strap end 46 is removably attachable to the grating/surface 12 adjacent the wheel 11 at a second grating position opposite the first grating position at which the plate and brace assemblies 13 and 14 are attached. The second strap end is attached to the spooling device 35 via a strap routing bar 43, which bar is depicted and referenced in FIGS. 1, 41, and 42. A strap length extends intermediate the first and second strap ends, which strap length is extendable adjacent a wheel arc length of the wheel 11 as generally depicted in FIG. 1. The second strap end is adjustably affixed at the first grating position for imparting a net force (as at vector arrow 109) directed towards the grating/surface 12 for strap-retaining the wheel 11 upon the grating/surface 12 intermediate the first and second grating positions via strap tension (as at vector arrow(s) 110) and a strap-to-wheel contact surface area.

A downward force (as directed from a foot, for example) operates to rotate the reel bars and tighten the strap 34. The strap assembly 15 is designed only for tensioning the strap 34. After a wheel-retaining tension 110 is applied to the strap 34, vertical movement of the wheel 11 is limited/restricted and the wheel 11 cannot otherwise climb the wheel-engaging structure 25 or become otherwise vertically displaced thereby overcoming many of the shortcomings inherent in the state of the art wheel restraint systems. In order to remove the tension 110 from the strap 34 at unloading, the drum-locking pawl 38 is engaged via the override 36 and foot release lever 39 thereby allowing the reel bars to unwind and remove strap tension 110. The strap 34 can then be manually pulled off and the strap end at 46 disengaged from the grating/surface 12.

The brace assembly 14 can then be disengaged from the wheel 11 thereby removing wheel-restricting force vector 111 (as referenced in FIG. 1) by foot operating the foot locking paddle 30. The paddle 30 if provided with an impulsive force (as at vector 112 in FIG. 34) directed upward, the lifter assembly 27 will rotate (as at arrow 113 in FIG. 34) about the axis 102 to release its engagement with the toothed rack(s) 28 and enable displacement of the link 24 away from the wheel 11. The plate assembly 13 may be disengaged from the grating/surface 12 by swiveling the bars 31 (via handles 44) to the stowed position, which action enables rotation about axis 100. The wheel restraint assembly 10 is thus free to be removed from the grating/surface 12 and stored or reapplied as necessary.

While the above description contains much specificity, this specificity should not be construed as limitations on the scope of the invention, but rather as an exemplification of the invention. For example, the foregoing teachings may be said to further support a wheel restraint assembly preventing wheel displacement, which wheel restraint assembly essentially comprises a bifurcated brace assembly (i.e. plate assembly 13 and brace assembly 14 as attached to one another). The bifurcated brace assembly comprises pivotally connected (as at axis 100), a first brace portion (portion 17 and anchor structure 22), a second brace portion (portion 18 and brace-locking means 26), support-attachment structure (e.g. grating-receiving structure 21), pivotable wheel-engaging structure (e.g. wheel-engaging structure 25 as pivotable about axis 103, anchoring means for pivotally anchoring a first brace end of the wheel-engaging structure to the first brace portion (e.g. the vertical height position slots as at 55 in FIGS. 15 and 16), and brace-locking means for selectively translating and locking a second brace end of the wheel-engaging structure to the second brace portion.

A wheel such as wheel 11 is positionable upon a support surface such as grating/surface 12. The brace assembly according to the present invention is attachable to the support surface adjacent the wheel at a first support position via the support-attachment structure. The pivotally connected first and second brace portions are rotatable about a brace axis of rotation for attaching and detaching the brace assembly to and from the support surface. The brace-locking means enable a user to selectively translate the wheel-engaging structure into wheel engagement and selectively lock the wheel-engaging structure in wheel engagement.

Stated another way, the wheel restraint assembly according to the present invention is believed to essentially comprise a bifurcated base plate assembly and a wheel brace assembly. The base plate assembly comprises hingedly connected first and second plates, wherein each plate comprises first and second plate surfaces. The first plate surface comprises certain support-engaging structure such as grating-receiving structure 21. The wheel brace assembly comprises pivotable wheel-engaging structure, anchoring means for pivotally anchoring a first brace end of the wheel-engaging structure, and brace-locking means for selectively translating and locking a second brace end of the wheel-engaging structure. The anchoring and brace-locking means are attached to the first and second plates.

After a wheel is positioned upon a support surface, the plate assembly is attachable to the support surface adjacent the wheel at a first support position via the support-engaging structure. The hingedly connected first and second plates are rotatable about a plate-based axis for attaching and detaching the plate assembly to and from the support surface. The brace-locking means enable a user to selectively translate the wheel-engaging structure into wheel engagement, and selectively lock the wheel-engaging structure in wheel engagement.

It is contemplated that the bifurcated base plate assembly 13 is central to the practice of the invention as it enables the user to quickly and selectively position the wheel restraint assembly adjacent a surface supported wheel. The bifurcated base plate assembly is essentially a bifurcated interface intermediate certain select wheel restraint means and a support surface. Various wheel restraint means may be attached to the bifurcated interface for preventing wheel displacements and thus the wheel restraint assembly according to the present invention may be said to essentially comprise a bifurcated interface assembly and select restraint means for preventing wheel displacement(s). The interface assembly comprises pivotally connected first and second interface portions as may be defined by elements 17 and 18. Each interface portion comprises a lower or first interface surface and an upper or second interface surface. The first interface surface(s) comprise certain support-engaging structure.

The select restraint means are attached to a select interface portion (as selected from the group consisting of the first and second interface portions) at the second interface surface. The interface assembly is attachable to a support surface adjacent a surface-supported wheel at a first support position via the support-engaging structure. The pivotally connected first and second interface portions are rotatable about an interface-based axis (as at 100) for attaching and detaching the interface assembly to and from the support surface. In other words, the pivoting action operates to attach and detach the interface assembly depending on the rotational direction. The select restraint means are selectively engageable with the surface-supported wheel at a select contact point for preventing wheel displacement toward the select contact point.

It is further contemplated that the select restraint means may be selected from the group comprising (1) certain means for preventing lateral wheel displacement relative to the support surface such as the lateral restraint arm or member 16, (2) certain means for preventing longitudinal wheel displacement relative to the support surface such as the wheel brace assembly 14, and (3) certain means for preventing vertical wheel displacement relative to the support surface such as the strap assembly 15.

A further key feature of the present invention is the pivotable wheel-engaging structure, which structure effectively functions to eliminate gaps intermediate the brace assembly when the linkages are translated into engagement with the surface-supported wheel. In this regard, it is thus contemplated that the wheel restraint assembly may be said to essentially comprise a wheel-engaging brace assembly and certain interfacing means for interfacing the brace assembly to a select support surface.

The wheel-engaging brace assembly comprises pivotable wheel-engaging structure, certain anchoring means for pivotally anchoring a first brace end of the wheel-engaging structure, and brace-locking means for selectively translating and locking a second brace end of the wheel-engaging structure. The interfacing means function to interface the brace assembly to a support surface. The anchoring and brace-locking means are attached to the interfacing means, and the interfacing means are attachable to the support surface adjacent a surface-supported wheel. The brace-locking means enable a user to (1) selectively translate the wheel-engaging structure into wheel engagement, and (2) selectively lock the wheel-engaging structure in wheel engagement.

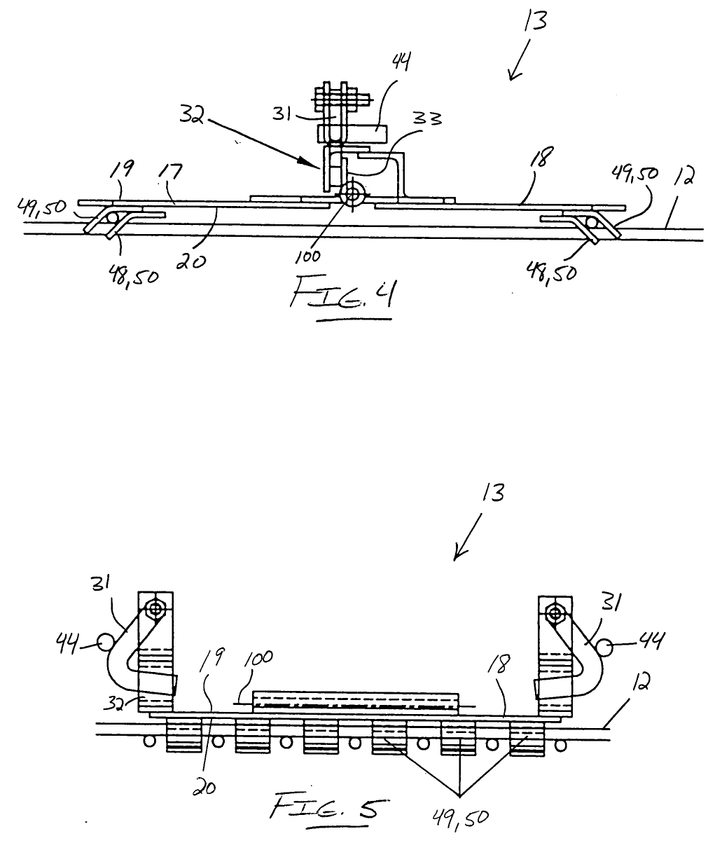

Still further, it is contemplated that the teachings set forth hereinabove support certain methodology for preventing wheel displacements. In this regard, it is contemplated that the subject invention may be said to further teach a method for preventing wheel displacement, which method comprises an initial step of tangentially positioning a wheel upon a support surface thereby surface-supporting the wheel as generally depicted in FIG. 1 at reference numeral 120. After surface-supporting a wheel, the method contemplates pivoting a bifurcated brace assembly a first direction adjacent the surface-supported wheel for attaching the brace assembly to the support surface adjacent the wheel. The pivoting action of the brace assembly is comparatively depicted in FIG. 2 versus FIG. 4 and FIG. 3 versus FIG. 5. Further, FIG. 7 attempts to capture the action in a single comparative depiction.

After pivotally attaching the bifurcated brace assembly to the support surface a first brace portion may be translated toward the wheel from a first brace position. FIGS. 11 and 17 depict the brace assembly in a first brace configuration with the link 24 in a first link position. FIGS. 12 and 18 depict the brace assembly in an unlocked second brace configuration wherein the link 24 is in a second, longitudinally displaced second link position. As the link 24 is translated toward the wheel 11, the wheel-engaging structure or a second brace portion tangentially pivots for maximizing the wheel-to-plate or wheel-to-structure contact surface area. When the structure 25 is in a substantially tangential position, the brace-locking means may be engaged for locking the translated first brace portion in the second brace position. The locked first brace portion maintains the configuration of the pivoted second brace portion and prevents rolling wheel displacement or wheel displacements along its circumference via opposing forces as at vector arrow 111.

The method may be said to further comprise the steps of vertically adjusting the first brace portion before translating said portion towards the wheel as may be enabled by slots 55. Further, the wheel may be strap-retained upon the support surface after locking the first brace portion in the second brace position for preventing orthogonal wheel displacement relative to the support surface via opposing forces as at vector arrow 109. The wheel may further be axially-retained relative to its own axis after locking the translated first brace portion. If the user wishes to displace the wheel, as for example, during unloading, the method further contemplates unlocking the first brace portion from the second brace position and translating the first brace portion toward the first brace position, and pivoting the bifurcated brace assembly a second direction thereby detaching the brace assembly from the support surface.

Accordingly, although the invention has been described by reference to certain preferred embodiments, and certain methodology, it is not intended that the novel assembly or methodology be limited thereby, but that modifications thereof are intended to be included as falling within the broad scope and spirit of the following claims and the appended drawings.

I claim:

1. A wheel restraint assembly, the wheel restraint assembly for preventing wheel displacement, the wheel restraint assembly comprising:
a bifurcated base plate assembly, the base plate assembly comprising pivotally connected first and second plates, each plate comprising first and second plate surfaces, the first plate surfaces comprising support-engaging structure; and
a wheel brace assembly, the wheel brace assembly comprising pivotable wheel-engaging structure, anchoring means for pivotally anchoring a first brace end of the wheel-engaging structure, and brace-locking means for selectively translating and locking a second brace end of the wheel-engaging structure, the anchoring and brace-locking means being attached to the first and second plates at the second plate surfaces, the plate assembly being attachable to a support surface adjacent a surface-supported wheel at a first support position via the support-engaging structure, the pivotally connected first and second plates being rotatable about a plate-based axis for attaching and detaching the plate assembly to and from the support surface, the brace-locking means enabling a user to selectively translate the wheel-engaging structure into wheel engagement, and selectively lock the wheel-engaging structure in wheel engagement.

2. The wheel restraint assembly of claim 1 wherein the support-engaging structure is defined by parallel rows of teeth engageable with a support surface defined by grating structure, the rows of teeth comprising tooth pairs, the tooth pairs defining an axis receiving channel, the axis-receiving channels having a substantially uniform channel axis for receiving axial grating structure.

3. The wheel restraint assembly of claim 2 wherein the first and second plates are rotatable intermediate an assembly-installation angle and the assembly-installed angle, the axis-receiving channels comprising a channel mouth and a channel bottom, channel-axis-receivable grating structure being receivable at the channel mouth at the assembly-installation angle and stoppable at the channel bottom at the assembly-installed angle.

4. The wheel restraint assembly of claim 3 wherein the second plate surfaces comprise plate-locking means for preventing pivot action intermediate the first and second plates when the first and second plates are in an assembly-installed position.

5. The wheel restraint assembly of claim 4 wherein the plate-locking means comprise a pin mechanism and opposing plate structures, the opposing plate structures being spaced in the assembly-installed position, the pin mechanism being sized and shaped for insertion via the spaced plate structures for preventing pivot action intermediate the first and second plates.

6. The wheel restraint assembly of claim 1 comprising a strap assembly, the strap assembly comprising a tensionable strap, the strap comprising first and second strap ends, the first strap end being removably attachable to the support surface adjacent the wheel at a second support position, the second strap end being adjustably affixed at the first support position, the strap for strap-retaining the wheel upon the support surface via an imposable strap tension.

7. The wheel restraint assembly of claim 6 wherein the strap assembly comprises tension-modifying means for modifying the imposable strap tension, the modifiable strap tension for modifying strap-retaining forces against the wheel.

8. The wheel restraint assembly of claim 1 comprising a lateral restraint member, the lateral restraint member being engageable with the wheel for preventing axial displacement of the wheel relative to the wheel restraint assembly.

9. The wheel restraint assembly of claim 1 wherein the anchoring means comprise a plurality of anchor settings, the anchor settings for enabling the user to selectively anchor the first brace end, the selectively anchorable first brace end for accommodating wheels of varying radii.

10. A wheel restraint assembly, the wheel restraint assembly for preventing wheel displacement, the wheel restraint assembly comprising:
a bifurcated brace assembly, the brace assembly comprising pivotally connected first and second brace portions, support-attachment structure, pivotable wheel-engaging structure, anchoring means for pivotally anchoring a first brace end of the wheel-engaging structure to the first brace portion, and brace-locking means for selectively translating and locking a second brace end of the wheel-engaging structure to the second brace portion, the brace assembly being attachable to a support surface adjacent a surface-supported wheel at a first support position via the support-attachment structure, the pivotally connected first and second brace portions being rotatable about a brace-based axis of rotation for attaching and detaching the brace assembly to and from the support surface, the brace-locking means enabling a user to selectively translate the wheel-engaging structure into wheel engagement and selectively lock the wheel-engaging structure in wheel engagement.

11. The wheel restraint assembly of claim 10 comprising plate-locking means for preventing pivot action intermediate the first and second brace portions when the first and second brace portions are in an assembly-installed position.

12. The wheel restraint assembly of claim 11 wherein the plate-locking means comprise a pin mechanism and opposing plate structures, the opposing plate structures being spaced in the assembly-installed position, the pin mechanism being sized and shaped for insertion intermediate the spaced plate structures for preventing pivot action intermediate the first and second brace portions.

13. The wheel restraint assembly of claim 10 comprising a strap assembly, the strap assembly comprising a tensionable strap, the strap comprising first and second strap ends, the first strap end being removably attachable to the support surface adjacent the wheel at a second support position, the second strap end being adjustably affixed at the first support position, the strap for strap-retaining the wheel upon the support surface via an imposable strap tension.

14. The wheel restraint assembly of claim 13 wherein the strap assembly comprises tension-modifying means for modifying the imposable strap tension, the modifiable strap tension for modifying strap-retaining forces against the wheel.

15. The wheel restraint assembly of claim 10 comprising a lateral restraint member, the lateral restraint member being engageable with the wheel for preventing axial displacement of the wheel relative to the wheel restraint assembly.

16. The wheel restraint assembly of claim 10 wherein the anchoring means comprise a plurality of anchor settings, the anchor settings for enabling the user to selectively anchor the first brace end, the selectively anchorable first brace end for accommodating wheels of varying radii.

17. The wheel restraint assembly of claim 10 wherein the support-attachment structure is defined by rows of teeth engageable with a support surface defined by grating structure, the rows of teeth comprising tooth pairs, the tooth pairs defining an axis receiving channel, the axis-receiving channels having a substantially uniform channel axis for receiving axial grating structure.

18. The wheel restraint assembly of claim 17 wherein the pivotally connected first and second brace portions are rotatable intermediate an assembly-installation angle and the assembly-installed angle, the axis-receiving channels comprising a channel mouth and a channel bottom, channel-axis-receivable grating structure being receivable at the channel mouth at the assembly-installation angle and stoppable at the channel bottom at the assembly-installed angle.

19. A wheel restraint assembly for preventing wheel displacement, the wheel restraint assembly comprising:
a bifurcated brace assembly, the brace assembly comprising pivotally connected first and second brace portions, surface-attachment means for removably attaching the first and second brace portions to a support surface, wheel-engagement structure, and brace-locking means for selectively translating and locking a first brace end of the wheel-engaging structure to the second brace portion, the brace assembly being attachable to a support surface adjacent a surface-supported wheel via the surface-attachment means, the pivotally connected first and second brace portions being rotatable about a brace-based axis of rotation for attaching and detaching the brace assembly to and from the support surface, the brace-locking means enabling a user to selectively translate the wheel-engaging structure into wheel engagement and selectively lock the wheel-engaging structure in wheel engagement.

20. The wheel restraint assembly of claim 19 comprising anchoring means for pivotally anchoring a second brace end of the wheel-engaging structure to the first brace portion.

21. The wheel restraint assembly of claim 20 wherein the anchoring means comprise a plurality of anchor settings, the anchor settings for enabling the user to selectively anchor the second brace end, the selectively anchorable second brace end for accommodating wheels of varying radii.

22. The wheel restraint assembly of claim 19 comprising pivotable wheel-engaging structure, the pivotable wheel-engaging structure for maximizing wheel-to-structure contact surface area when the user selectively translates the wheel-engaging structure into wheel engagement.

23. A wheel restraint assembly, the wheel restraint assembly for preventing wheel displacement, the wheel restraint assembly comprising:
a bifurcated interface assembly, the interface assembly comprising pivotally connected first and second interface portions, each interface portion comprising first and second interface surfaces, the first interface surface comprising support-engaging structure; and
select restraint means for preventing wheel displacement, said means being attached to a select interface portion at the second interface surface, the interface assembly being attachable to a support surface adjacent a surface-supported wheel at a first support position via the support-engaging structure, the pivotally connected first and second interface portions being rotatable about an interface-based axis for attaching and detaching the interface assembly to and from the support surface, the restraint means being selectively engageable with the surface-supported wheel at a select contact point for preventing wheel displacement toward the select contact point.

24. The wheel restraint assembly of claim 23 wherein the select restraint means are selected from the group comprising means for preventing lateral wheel displacement relative to the support surface, means for preventing longitudinal wheel displacement relative to the support surface, and means for preventing vertical wheel displacement relative to the support surface.

25. A wheel restraint assembly, the wheel restraint assembly for preventing wheel displacement, the wheel restraint assembly comprising:
a wheel-engaging brace assembly, the brace assembly comprising pivotable wheel-engaging structure, anchoring means for pivotally anchoring a first brace end of the wheel-engaging structure, and brace-locking means for selectively translating and locking a second brace end of the wheel-engaging structure; and
interfacing means for interfacing the brace assembly to a support surface, the anchoring and brace-locking means being attached to the interfacing means, and the interfacing means being attachable to the support surface adjacent a surface-supported wheel, the brace-locking means enabling a user to selectively translate the wheel-engaging structure into wheel engagement, and selectively lock the wheel-engaging structure in wheel engagement.

26. A method for selectively preventing surface-borne wheel displacement, the method comprising the steps of:
tangentially surface-supporting a wheel;
pivoting a bifurcated brace assembly a first direction adjacent the surface-supported wheel thereby attaching the brace assembly to the support surface adjacent the wheel;
translating a first brace portion toward the wheel from a first brace position;
tangentially pivoting a second brace portion against the wheel;
locking the translated first brace portion in a second brace position, the locked first brace portion for maintaining the pivoted second brace portion and preventing circumferential wheel displacement.

27. The method of claim 26 comprising the step of vertically adjusting the first brace portion before translating said portion towards the wheel.

28. The method of claim 26 comprising the step of strap-retaining the wheel upon the support surface after locking the first brace portion in the second brace position thereby preventing orthogonal wheel displacement relative to the support surface.

29. The method of claim 26 comprising the step of axially-retaining the wheel after locking the translated first brace portion for preventing axial wheel displacement.

30. The method of claim 26 comprising the steps of unlocking the first brace portion from the second brace position and translating the first brace portion toward the first brace position.

31. The method of claim 30 comprising the step of pivoting the bifurcated brace assembly a second direction thereby detaching the brace assembly from the support surface.

32. A method for selectively preventing surface-borne wheel displacement, the method comprising the steps of:
pivoting a bifurcated brace assembly a first direction adjacent a surface-supported wheel thereby attaching the brace assembly to the support surface adjacent the wheel;
displacing a first brace portion toward the wheel from a first brace position;
locking the displaced first brace portion preventing circumferential wheel displacement.

33. The method of claim 32 comprising the step of tangentially pivoting a second brace portion against the wheel.

34. The method of claim 33 wherein the step of locking the displaced first brace portion maintains the pivoted second brace portion.

35. The method of claim 32 comprising the step of vertically adjusting the first brace portion before displacing said portion.

36. The method of claim 32 comprising the step of strap-retaining the wheel upon the support surface after locking the displaced first brace portion for preventing orthogonal wheel displacement relative to the support surface.

37. The method of claim 32 comprising the step of axially-retaining the wheel after locking the displaced first brace portion for preventing axial wheel displacement.

38. The method of claim 32 comprising the steps of unlocking the displaced first brace portion and reducing the net displacement thereof.

39. The method of claim 38 comprising the step of pivoting the bifurcated brace assembly a second direction thereby detaching the brace assembly from the support surface.
